(19) United States
(12) Patent Application Publication
(10) Pub. No.: US 2011/0114695 A1
(43) Pub. Date: May 19, 2011

(54) Three-in-One Nail Gun Nail-Box Unit

(75) Inventors: Mingjun Yang, Zhejiang (CN); Cong Li, Zhejiang (CN); Jianjun Ye, Zhejiang (CN)

(73) Assignee: TAIZHOU DAJIANG IND., CO., LTD., Wenling, Zhejiang (CN)

(21) Appl. No.: 12/812,656

(22) PCT Filed: Jan. 11, 2010
(86) PCT No.: PCT/CN2010/070116

§ 371 Date: Jul. 13, 2010

(30) Foreign Application Priority Data
Sep. 25, 2009 (CN) 200910153186.3

(51) Int. Cl. B25C 1/00

(52) U.S. Cl. 227/109

(57) ABSTRACT

The invention relates to a three-in-one nail gun nail-box unit, comprising: a groove, on which a U-shaped nail can straddle and slide and one end of which is connected with the head of the nail gun; a nail clip, which is arranged on the periphery of the groove; a nail-pushing block, the end section of which is U-shaped and which is connected with the gun body via an elastomer in order to push the nails to move in the direction of the head of the nail gun; two sides of the groove are respectively enclosed by the nail clip, in order to form a first accommodation groove and a second accommodation groove for accommodating the nails to pass through, and the sidewalls of the accommodation grooves are oppositely provided with protrusions for defining the head of nails; a positioning block fixedly connected to the nail clip is arranged above the groove, and the bottom of the positioning block is matched with the top of the groove to define the position of the U-shaped nail; and the side of the positioning block is matched with the nail clip to form the inner side of the first accommodation groove. The three-in-one nail gun nail-box unit has the advantage of being capable of adapting to F-shaped nails, U-shaped nails and T-shaped nails simultaneously, and wide range of use.

### FIELD OF THE INVENTION

The invention relates to a nail gun nail-box unit, more particularly to a nail gun nail-box unit which can be used for multi-specification nails simultaneously.

### BACKGROUND OF THE INVENTION

Although the nail-box unit for the alternative use of F-shaped nails and U-shaped nails has been developed quite maturely in current nail gun nail-box structures, higher requirements for the universality of nail-box unit in terms of the shape of nails have been come up with during practices as the application field of the nail gun is ceaselessly widened and the number of the shapes of the used nails is increased. Furthermore, it is required in nailing operation that the nail-box unit can not only adapt to F-shaped nails and U-shaped nails, but also can adapt to T-shaped nails simultaneously.

As another example, a nail-box unit of dual-purpose nail guns for T-shaped and U-shaped nails is disclosed in China Publication Patent Number CN2340569Y, the device comprises a groove and a slide box which is positioned on the periphery thereof in slide matching therewith, —the slide box is axially provided with a sleeved space, the wall face of which is apart from the groove so that a U-shaped nail can be arranged, and the surface of one side of the groove and the wall face of the sleeved space of the slide box are provided with a plurality of opposite groove channels which are used for the arrangement of T-shaped nails with different lengths. The technology has the advantage that : the nail-box unit can adapt to T-shaped and U-shaped nails and includes consistent arrangement manner of the nails and simple, convenient arrangement operation of the nails.

However, the prior art described above has the deficiency that: the nail passing groove for T-shaped nails is only arranged at one side of the groove on which a U-shaped nail can straddle and slide; and owing to the unchanged spacing between the nail clip and the groove, the nail-box unit can only adapt to T-shaped nails or F-shaped nails both having one wire diameter, which means narrow application range thereof.

### SUMMARY OF THE INVENTION

In order to solve the technical problems, the present invention provides a nail gun nail-box unit which can adapt to F-shaped nails, U-shaped nails and T-shaped nails simultaneously. The technical proposal as follow is adopted to solve the above technical problems : a three-in-one nail gun nail-box unit, comprising:
a groove, on which a U-shaped nail can straddle and slide, and one end of which is connected with the head of the nail gun;
a nail clip, which is arranged on the periphery of the groove;
a nail-pushing block, the end section of which is U-shaped and which is connected with the gun body via an elastomer in order to push the nails to move in the direction of the head of the nail gun;
and characterized in that: two sides of the groove are respectively enclosed by the nail clip, in order to form a first accommodation groove and a second accommodation groove for accommodating the nails to pass through, and the sidewalls of the accommodation grooves are oppositely provided with protrusions for defining the head of nails; a positioning block fixedly to the nail clip is arranged above the groove, and the bottom of the positioning block is matched with the top of the groove to define the position of the U-shaped nail; and the side of the positioning block is matched with the nail clip to form the inner side of the first accommodation groove.

Further, the sidewalls of the accommodation grooves are provided with a plurality of protrusions in order to adapt to T-shaped nails and F-shaped nails with different heights. Further, the bottoms of the first accommodation groove and the second accommodation groove are provided with abrasion-resistant inserts.

Further, one end of the groove and the nail clip is connected with the gun head, while the other end is provided with a support. Further, the U-shaped nail-pushing end of the nail-pushing block is tooth-shaped.

Further, the elastomer is hooked at the end of the nail clip of the nail gun via a hook.

Further, the gun head comprises a gun nozzle, a cover plate and a gun needle, wherein the gun nozzle is formed with a first nail passing groove and a second nail passing groove respectively corresponding to the first accommodation groove and the second accommodation groove, as well as a U-shaped nail passing channel; the gun needle comprises a first branch matched with the first nail passing groove and a second branch matched with the second nail passing groove.

According to the invention, since two sides of the groove are provided with nail passing accommodation grooves, the nail-box unit can adapt to F-shaped and T-shaped nails respectively, and can also adapt to T-shaped nails having two different wire diameters or F-shaped nails having two different wire diameters, therefore, the range of application is widened. And meanwhile, the inner sidewalls of the accommodation grooves are provided with a plurality of protrusions which can adapt to F-shaped and T-shaped nails with different heights.

The nail gun nail-box unit has the advantage of: being capable of adapting to three types of nails, and wide range of use.

### BRIEF DESCRIPTION OF THE DRAWINGS

FIG. 1 is a stereoscopic diagram for the invention.

FIG. 2 is a schematic diagram for the disassembly of the invention.

FIG. 3 is a schematic diagram for the arrangement of T-shaped nails inside the first accommodation groove.

FIG. 4 is a schematic diagram for the arrangement of T-shaped nails inside the second accommodation groove.

FIG. 5 is a schematic diagram for the arrangement of U-shaped nails inside the accommodation grooves.

FIG. 6 is a schematic diagram for the arrangement of F-shaped nails inside the first accommodation groove.

FIG. 7 is a schematic diagram for the arrangement of F-shaped nails inside the second accommodation groove.

FIG. 8 is a schematic diagram for the nail-pushing block.

FIG. 9 is a schematic diagram for the gun nozzle.

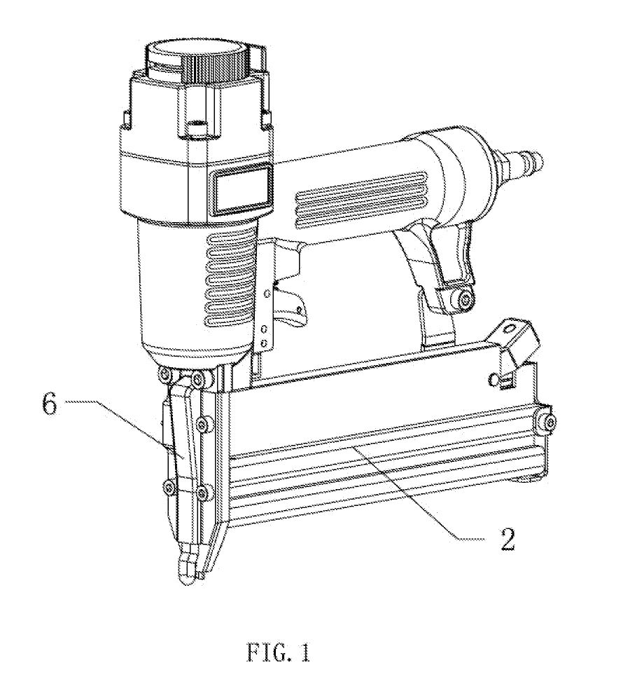

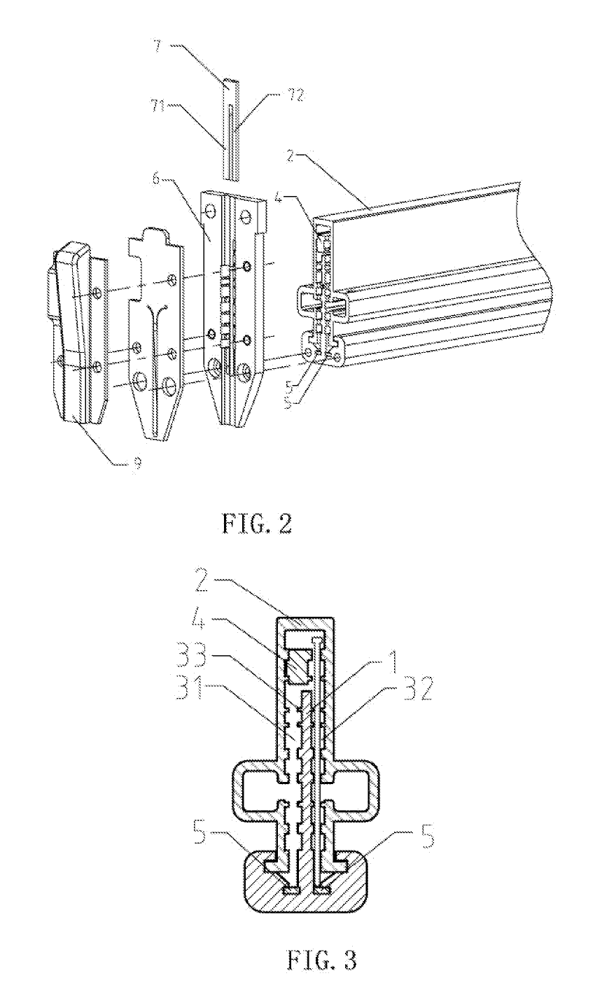

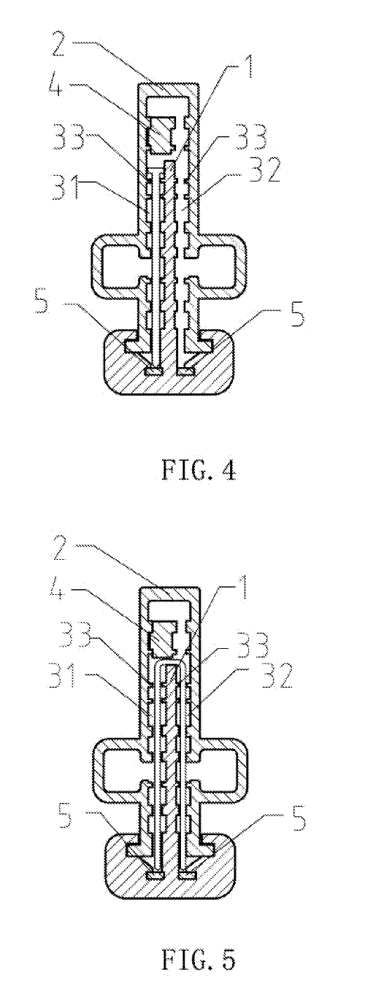

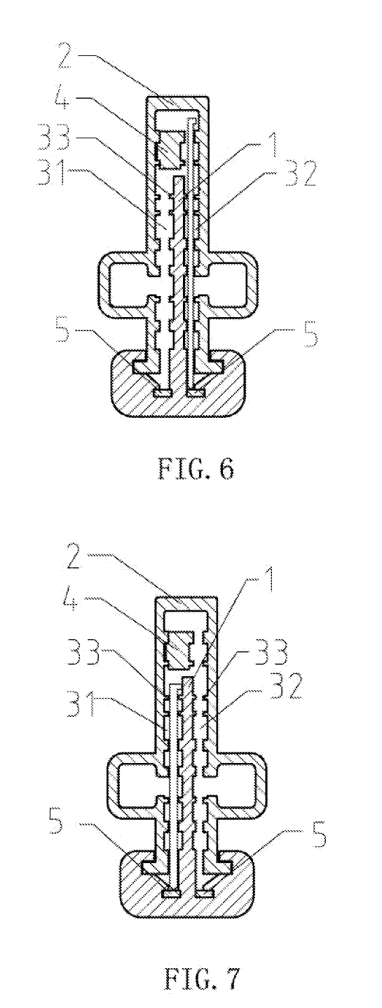

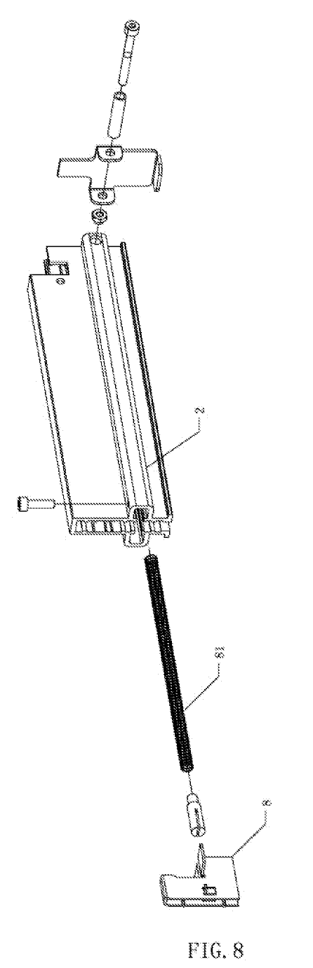

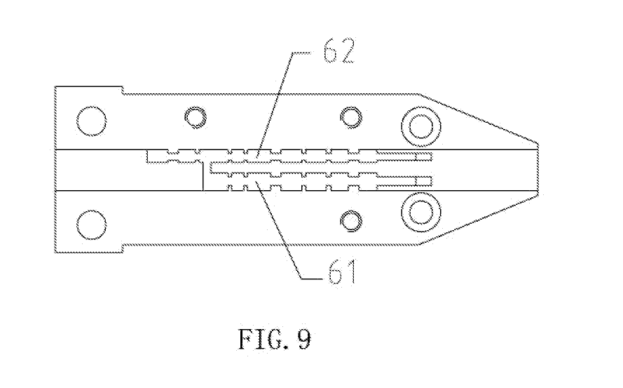

### DETAILED DESCRIPTION OF THE INVENTION

Further description is made to the present invention in reference to drawings:
a three-in-one nail gun nail-box unit, comprising:
a groove 1, on which a U-shaped nail can straddle and slide and one end of which is connected with the head of the nail gun;
a nail clip 2, which is arranged on the periphery of the groove 1;
a nail-pushing block 8, the end section of which is U-shaped and which is connected with the gun body via an elastomer 81
in order to push the nails to move in the direction of the head of the nail gun;
two sides of the groove 1 are respectively enclosed by the nail clip 2 , in order to form a first accommodation groove 31 and a second accommodation groove 32 for accommodating the nails to pass through, and the sidewalls of the accommodation grooves 31, 32 are oppositely provided with protrusions 33 for defining the head of nails; a positioning block 4 fixedly connected to the nail clip is arranged above the groove 1, and the bottom of the positioning block 4 is matched with the top of the groove 1 to define the position of the U-shaped nail; and the side of the positioning block 4 is matched with the nail clip 2 to form the inner side of the first accommodation groove 31. The sidewalls of the accommodation grooves are provided with a plurality of protrusions 33 in order to adapt to T-shaped nails and F-shaped nails with different heights.

The bottoms of the first accommodation groove 31 and the second accommodation groove 32 are provided with abrasion-resistant inserts 5.

One end of the groove 1 and the nail clip 2 is connected with the gun head, while the other end is provided with a support. The U-shaped nail-pushing end of the nail-pushing block 8 is tooth-shaped.

The elastomer 81 is hooked at the end of the nail clip 2 of the nail gun via a hook. The elastomer 81 is respectively arranged inside two square grooves of the nail clip 2 and is limited by the cover plate at the bottom and screws at the top.

The gun head comprises a gun nozzle 6, a cover plate 9 and a gun needle 7, wherein the gun nozzle is formed with a first nail passing groove 61 and a second nail passing groove 62 respectively corresponding to the first accommodation groove 31 and the second accommodation groove 32, as well as with a U-shaped nail passing channel; the gun needle 7 comprises a first branch 71 matched with the first nail passing groove 61 and a second branch 72 matched with the second nail passing groove 62.

According to the invention, since two sides of the groove 1 are provided with nail passing accommodation grooves 31, 32, the nail-box unit can adapt to F-shaped and T-shaped nails respectively, and can also adapt to T-shaped nails or F-shaped nails both having two different wire diameters, therefore, the range of application is widened. And meanwhile, the inner sidewalls of the accommodation grooves 31, 32 are provided with a plurality of protrusions 33 which can adapt to F-shaped and T-shaped nails with different heights.

The description above for the embodiments of the invention, aiming at giving a better understanding of the invention only, should not be considered to be limitation to the invention. Various changes and equivalents thereof without departing from the spirit and the scope of the invention, made by the skilled in the related arts, fall into the protection scope of the invention.

What is claimed is :

1. A three-in-one nail gun nail-box unit, comprising:
a groove, on which a U-shaped nail can straddle and slide and one end of which is connected with the head of the nail gun;
a nail clip, which is arranged on the periphery of the groove;
a nail-pushing block, the end section of which is U-shaped and which is connected with the gun body via an elastomer in order to push the nails to move in the direction of the head of the nail gun;
and characterized in that: two sides of the groove are respectively enclosed by the nail clip, in order to form a first accommodation groove and a second accommodation groove for accommodating the nails to pass through, and the sidewalls of the accommodation grooves are oppositely provided with protrusions for defining the head of nails; a positioning block fixedly connected to the nail clip is arranged above the groove, and the bottom of the positioning block is matched with the top of the groove to define the position of the U-shaped nail; and the side of the positioning block is matched with the nail clip to form the inner side of the first accommodation groove.

2. The three-in-one nail gun nail-box unit according to claim 1, characterized in that: the sidewalls of the accommodation grooves are provided with a plurality of protrusions in order to adapt to T-shaped nails and F-shaped nails with different heights.

3. The three-in-one nail gun nail-box unit according to claim 2, characterized in that: the bottoms of the first accommodation groove and the second accommodation groove are provided with abrasion-resistant inserts.

4. The three-in-one nail gun nail-box unit according to claim 3, characterized in that: one end of the groove and the nail clip is connected with the gun head, while the other end is provided with a support.

5. The three-in-one nail gun nail-box unit according to claim 4, characterized in that: the gun head comprises a gun nozzle, a cover plate and a gun needle, the gun nozzle is formed with a first nail passing groove and a second nail passing groove respectively corresponding to the first accommodation groove and the second accommodation groove, as well as a U-shaped nail passing channel; the gun needle comprises a first branch matched with the first nail passing groove and a second branch matched with the second nail passing groove.

6. The three-in-one nail gun nail-box unit according to claim 5, characterized in that: the U-shaped nail-pushing end of the nail-pushing block is tooth-shaped.

7. The three-in-one nail gun nail-box unit according to claim 6, characterized in that: the elastomer is hooked at the end of the nail clip of the nail gun via a hook.
